(19) United States
(12) Patent Application Publication
(10) Pub. No.: US 2019/0150657 A1
(43) Pub. Date: May 23, 2019

(54) UNIT, INCLUDING A CAPSULE, FOR PREPARING INFUSIONS

(71) Applicant: CUP OUT OF THE BOX, S.L., Venta de Baños (Palencia) (ES)

(72) Inventor: Patricia GARCÍA RÍOS, Venta de Baños (ES)

(73) Assignee: CUP OUT OF THE BOX, S.L., Venta de Baños (Palencia) (ES)

(21) Appl. No.: 16/067,320

(22) PCT Filed: Jun. 3, 2016
(86) PCT No.: PCT/ES2016/070417

§ 371 Date: Nov. 1, 2018

(30) Foreign Application Priority Data
Jan. 5, 2016 (ES) P201630004

(51) Int. Cl. A47J 31/36; B65D 85/804; A47J 31/06

(52) U.S. Cl. CPC A47J 31/3676; A47J 31/0684; A47J 31/0668; B65D 85/8043

(57) ABSTRACT

Unit, capsule and method for preparing infusions. The unit comprises a capsule (2) and a device (100) for preparing infusions. The capsule (2) has a cup-shaped main body (6) open at one end. This end is closed with a lid (26) and forms an inner chamber (4). From said end there projects a perimetrical rim (12) having a sealing member (14) with an annular groove (16) formed between the side wall (18) of the main body (6) and a remote wall (20). The device (100) comprises an enclosing member (102) configured to receive the capsule (2) and having a leading sealing edge (104) which, in the operative position, is inserted in the groove (16) and is sealingly compressed simultaneously on the side wall (18) of the main body (6) and the remote wall (20). The invention also relates to a method for preparing infusions with this unit.

### FIELD OF THE INVENTION

The invention relates to a unit for preparing infusions comprising a capsule comprising a cup-shaped main body defining a main axis and having an upper base and an open lower base, a lid for closing said lower base and forming an inner chamber with said main body in which there is contained an infusion product, a perimetrical rim projecting outwardly from said lower base and having an injection side and an extraction side, and a sealing member, provided on said injection side of said rim, and a device for preparing infusions comprising an enclosing member configured to receive said capsule and having a leading sealing edge, said device being configured to prepare an infusion by causing a liquid to pass under pressure through said inner chamber, said unit having a rest position in which said leading edge is remote from said sealing member and an operative position in which said leading sealing edge is compressed against said sealing member to provide fluid tightness during the preparation of said infusion.

The invention likewise relates to a capsule for use in a device for preparing infusions comprising a truncated-cone-shaped enclosing member configured to receive said capsule and having a circular leading sealing edge, said device being configured to prepare an infusion by causing a liquid to pass under pressure through said inner chamber and said leading edge having an inner diameter comprised between 29.8 and 30.4 mm and an outer diameter comprised between 30.6 and 32 mm, said capsule comprising a truncated cone cup-shaped main body defining a main axis and having an upper base and an open lower base, a lid for closing said lower base and forming an inner chamber with said main body in which there is contained an infusion product, a perimetrical rim extending outwardly from said lower base and having an injection side and an extraction side, and a sealing member, provided on said injection side of said rim.

Finally, the invention also to a method for preparing infusions comprising the steps of: inserting a capsule comprising a cup-shaped main body defining a main axis and having an upper base and an open lower base, a lid for closing said lower base and forming an inner chamber with said main body in which there is contained an infusion product, a perimetrical rim projecting outwardly from said lower base and having an injection side and an extraction side, and a sealing member, provided on said injection side of said rim, in a device for preparing infusions comprising an enclosing member configured to receive said capsule and having a leading sealing edge, said device being configured to prepare an infusion by causing a liquid to pass under pressure through said inner chamber, said unit having a rest position in which said leading edge is remote from said sealing member and an operative position in which said leading sealing edge is compressed against said sealing member to provide fluid tightness during the preparation of said infusion.

### State of the Art

The preparation of infusions of the type of tea, coffee or the like from units for preparing infusions formed by a device injecting a fluid, preferably hot water, under a pressure of between 1 and 20 bar in a capsule containing one or multiple doses of the infusion to be prepared, of the type described at the beginning is known.

One of the problems that this way of preparing infusions presents consists of it being complicated to achieve correct fluid tightness at the contact point between the enclosing member of the capsule holder of the machine and the rim of the capsule itself. The enclosing member bears with its leading edge on the sealing member of the capsule provided on the rim. Unless good fluid tightness is achieved at this bearing point, and fluid losses and a drop in the pressure of the fluid injected in the capsule occur. Consequently, the organoleptic properties of the beverage are directly affected. Examples of this way of preparing infusions are known from documents such as EP0512470A1, EP2303077A1, WO2014184652A1 or WO2014118812A1, which describe ways of approaching this problem.

In particular, EP2303077A1 discloses a solution in which to achieve the fluid tightness at the contact point between the enclosing member and the rim on which the capsule holder bears, the capsule is provided with a sealing member formed by a plurality of very closely spaced apart concentric annular lips. Thus, the leading edge of the enclosing member bears on the peaks of these lips to guarantee the fluid tightness of the system during the injection of the fluid. Such sealing member having the plurality of lips is directed to minimizing liquid losses should the enclosing member and the capsule be mutually offset. Nevertheless, particularly when the offset has occurred, the loss of a certain amount of liquid is not avoided. Thus, this solution only minimizes the problem.

WO2014184652A1 discloses a sealing member formed through a lip forming a trough in the capsule rim. Under this trough, on the extraction side of the capsule, the rim is provided with a step. When the capsule holder presses against the trough, owing to the step under the sealing member, the lip is deformed inwardly to block the outer surface of the enclosing member. In this case, there is also the risk of the capsule holder itself bearing on the trough in an offset way, such that not all the lip bears against the outer profile of the enclosing member. Also, when the offset is very great, the enclosing member can press the lip and then the desired effect of fluid tightness is not attained.

Finally, WO2014118812A1 discloses a capsule having a sealing member formed by two concentric lips remote from the main body of the capsule. The same as in the case of WO2014184652, there is provided on the extraction side of the capsule rim a step to facilitate the bearing of both ribs against the side walls of the enclosing member when the latter presses against the floor of the trough formed between both ribs. Once again in this case, the problem arises that the enclosing member might not correctly enter in the trough, reproducing the already described problems.

### SUMMARY OF THE INVENTION

It is an object of the invention to provide a unit for preparing infusions of the type indicated at the beginning, guaranteeing a good fluid tightness in the point of closure of the enclosing member on the capsule and that this fluid tightness may be effected in a simple, but reliable, way.

This purpose is achieved by a unit for preparing infusions of the type indicated at the beginning, characterized in that said sealing member comprises an annular groove surrounding the main body and which is formed by the side wall of said main body and a remote wall from said main body, said groove narrowing from the injection side towards the extraction side, and in that said groove and said leading edge are configured in such a way that, in the operative position, said leading edge is inserted in said groove and is sealingly compressed simultaneously on said side wall of said main body and said remote wall.

In the first place, it is important to highlight that it is not essential in the invention whether the enclosing member moves in the longitudinal direction or rocks relative to the capsule, but it may also be the other way round. Thus, in the invention, to pass from the rest position to the operative position, it is irrelevant which of these two members moves towards the other.

The narrowing of the annular groove and the shape of the leading edge of the enclosing member are configured and orientated in such a way that, in the operative position, the leading edge of the enclosing member contacts and then compresses the walls delimiting the groove. Thereby, firstly, thanks to one of the walls of the groove being the side wall proper of the capsule, direct guidance is achieved between the leading edge of the enclosing member and the capsule leading the enclosing member always ending to be inserted in the annular groove of the sealing member. This guarantees that the capsule is centered in the enclosing member such that the leading edge of the enclosing member has available two sealing curves on the sealing member. This notably improves the fluid tightness at this point.

Also, unlike other conventional solutions in which guidance is effected through the end of the capsule opposite to the end having the rim, in the invention, the guidance is effected precisely at the leading edge, that is, precisely at the point where it seeks to enter the groove to improve the fluid tightness. Consequently, the assembling between both members is more precise than in the known conventional solutions, in which the guidance is effected from the smaller base of the capsule and, therefore, the risk of offsetting of both parts was very high. In fact, in the conventional solutions, it usually happens that the leading edge of the enclosing member presses simultaneously on several annular protrusions, which allows liquid leak channels to be easily formed.

Thus, with this arrangement, two curves of contact with the walls delimiting the groove are obtained. In the case where a greater deformation occurs, these two sealing curves may be small annular surfaces, but in any case, owing to the reduced area thereof, the pressure exerted by the enclosing member on the walls of the groove increases and the fluid tightness is notably improved at this point. Should any fluid manage to cross through the first contact curve, that is, that of the inner diameter of the enclosing member in contact with the side wall of the capsule, the liquid, under a much lower pressure, will run up against the remote wall of the groove, which hinders the fluid losses in the sealing member. Consequently, the beverage may be prepared under high pressures and the best organoleptic properties thereof may be obtained.

The invention further includes a number of preferred features that are object of the dependent claims and the utility of which will be highlighted hereinafter in the detailed description of an embodiment of the invention.

Particularly preferably, the leading edge has an annular cross section defining an inner diameter and an outer diameter and said groove has a floor defining a floor diameter and said floor diameter is greater than said inner diameter of the enclosing member and smaller than said outer diameter of the enclosing member. Thus, reliable contact with both walls of the groove is guaranteed at all times.

Preferably, the capsule has the shape of a bell-shaped cup, which favours the guidance of the capsule from the time when the leading edge of the enclosing member makes contact with the side wall of the capsule.

In a particularly preferred embodiment, the capsule has the shape of a frustroconical bell-shaped cup allowing more progressive guidance and subsequent centering.

Particularly preferably, the capsule has a guide area on said side wall extending from the floor of said annular groove to at least one third of the height of said capsule, which starts the mutual guiding of capsule and enclosing member at a very early stage during the approach method and increases the correct centering of both parts together.

In a particularly preferred embodiment, the inner wall of said enclosing member and the side wall of said capsule have mating shapes in said guide area, which notably reduces the centering movements at the time prior to closure and minimizes the volume of liquid existing between the capsule and the enclosing member, such that when opening the device at the end of preparing the beverage, there are less losses of fluid.

In another embodiment, said remote wall of said sealing member is formed by a deformable annular protrusion. Also particularly preferably, said rib is plastically deformable to improve even more the fluid tightness. Nevertheless, said deformation may also be elastic.

Preferably, said remote wall comprises a plurality of punctual blind holes penetrating in said sealing member in such a way that said sealing member is deformable under pressure during the preparation of said infusion. Thereby, the sealing member its facilitates the occurrence of a plastic deformation of this wall of the sealing member under pressure during the preparation of said infusion, which improves the fluid tightness a little more.

In a preferred embodiment, said groove narrows from said injection side towards said extraction side asymmetrically to optimize on which side of the groove it is desired to obtain a greater fluid tightness. In an alternative embodiment, the groove could be symmetrical.

In another embodiment, the slope angle of said side wall of said main body relative to said main axis is greater than the slope angle of said remote wall relative to said main axis. Thanks to this, further to working on the fluid tightness, the centering angle of the capsule relative to the machine may be optimized and thereby the progressivity of the centering may be optimized.

Also, with a view to providing a capsule for preparing infusions indicated at the beginning which guarantees good fluid tightness in the closing area of the enclosing member on the capsule and that this fluid tightness may be obtained in a simple, but reliable way, the invention proposes a capsule of the type indicated at the beginning characterized in that the sealing member comprises an annular groove surrounding the main body and which is formed by the side wall of said main body and a remote wall from said main body, said groove narrowing from the injection side towards the extraction side and in that, said side wall in the region of said groove slopes between 14 and 17.50 relative to said main axis, said remote wall slopes between 15 and 450 relative to said main axis, the said groove has a maximum height comprised between 0.8 and 3 mm measured from the lowest point of said extraction side and a depth comprised between 0.5 and 1.5 mm measured from said maximum height, to the floor of said groove.

Finally, the invention relates to a method for preparing infusions from a capsule and a device such as those described above which is characterized the sealing member comprises an annular groove surrounding the main body and which is formed by the side wall of said main body and a remote wall from said main body, said groove narrowing from the injection side towards the extraction side, and in that in said operative position, said leading edge is inserted in said groove and is sealingly compressed simultaneously on said side wall of said main body and said remote wall prior to causing said liquid to pass under pressure through said inner chamber.

Likewise, the invention also includes other features of detail illustrated in the detailed description of an embodiment of the invention and in the accompanying figures.

### BRIEF DESCRIPTION OF THE DRAWINGS

Further advantages and features of the invention will become apparent from the following description, in which, without any limiting character, preferred embodiments of the invention are disclosed, with reference to the accompanying drawings in which:

Further advantages and features of the invention will become apparent from the following description, in which, without any limiting character, preferred embodiments of the invention are disclosed, with reference to the accompanying drawings in which:

FIG. 1 is a cross section view along a central plane of a first embodiment of a capsule according to the invention.

FIG. 2 is an enlarged detail of the region of the sealing member of the capsule of FIG. 1, with the unit for preparing infusions according to the invention in the operative position.

FIG. 3 is a partial section view of the unit for preparing infusions according to the invention, during the passage from the rest position to the operative position.

FIG. 4 is a partial section view of the unit for preparing infusions according to the invention, in the operative position.

FIG. 5 is an enlarged detail of the region of the sealing member of the capsule, with a second embodiment of the unit for preparing infusions according to the invention in the operative position.

FIG. 6 is a section view along a central plane of a second embodiment of a capsule according to the invention.

FIG. 7 is a cross section view along a central plane of a third embodiment of a capsule according to the invention.

FIG. 8 is an enlarged detail of the region of the sealing member of the capsule, with a third embodiment of the unit for preparing infusions according to the invention in the operative position.

### DETAILED DESCRIPTION OF EMBODIMENTS OF THE INVENTION

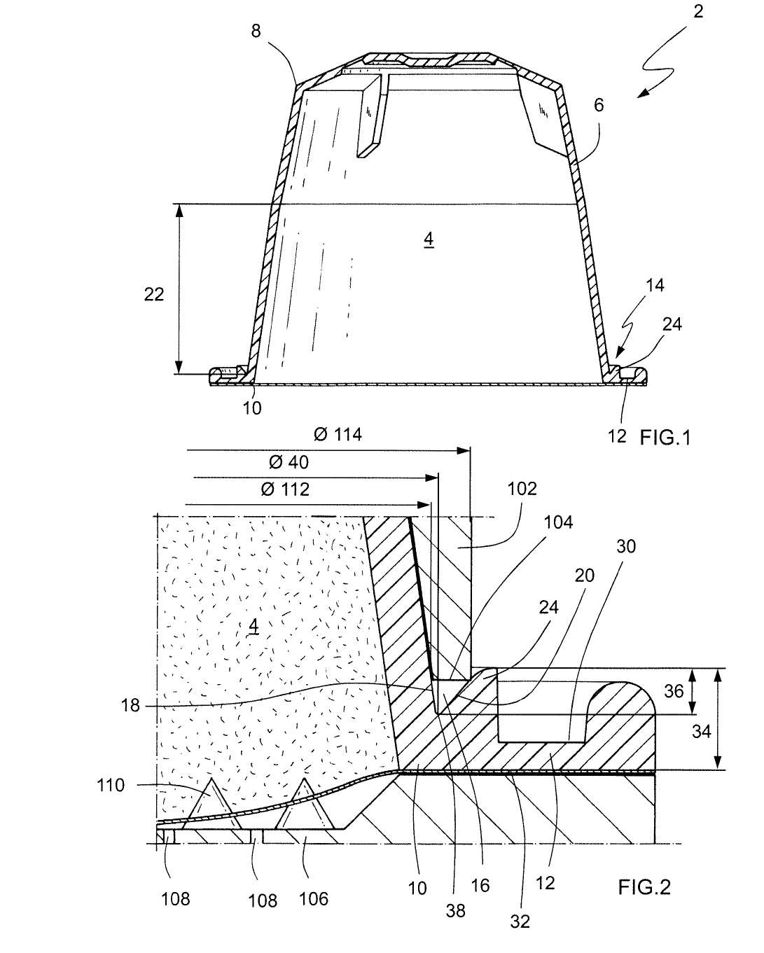

FIG. 1 shows a first embodiment of a capsule 2 for use in the unit 1 according to the invention.

The capsule 2 comprises a cup-shaped, preferably bell-shaped and, more preferably, a truncated-cone-shaped or cylindrical main body 6. In principal, the cross section of the capsule will be circular, but it could also have other forms, such as polygonal or the like.

The capsule 2, in this case of truncated cone shape, defines a main axis 28. The truncated cone has an upper base 8 and a lower base 10. In this embodiment, the upper base 8 ends forming a truncated-cone-shaped cap and is closed. Nevertheless, as will be seen in other embodiments, this upper base may be flat and have holes or be open and covered with a sheet. The upper base 8 could also end in the form of a spherical cap or other forms.

On the lower base 10 side, the capsule has a perimetrical rim 12 projecting outwardly from the main body 6. This rim 12 has an injection side 30, corresponding to the side where the main body 6 is and an extraction side 32. It will be seen in FIG. 1 that the on the extraction side 32, the capsule 2 has a lid 26 made from a sheet-like material, for closing the lower base 10 and forming an inner chamber 4 with the main body 6, in which there is contained an infusion product. The perimetrical rim 12 of the capsule according to the invention may also project outwardly forming an angle relative to the horizontal in the figures. Nevertheless, the rim 12 usually projects outwardly radially and on the plane perpendicular to the main axis 28 of the capsule 2.

In the preferred embodiment, the main body 6 and the lid 26 are made from materials having barrier properties. In the invention, a material having barrier properties refers to a material which does not let oxygen pass therethrough or allows it to pass at very low levels. Particularly preferably, the barrier materials according to the invention are those having an oxygen transmission rate (OTR) of less than or equal to 0.1 cm³/package per day. In the measurement the package of the oxygen transmission rate refers to a capsule closed with the lid itself. Thanks to this, infusion product is preserved longer and better in the inner chamber 4. Appropriate materials for providing barrier properties are, for example, high density polyethylene (HDPE), aluminium, materials composed of different layers of polymer and metals, cellulose or others. Also preferably, the main body 6 will be made by injection of a polymer or by forming from a sheet of aluminium or heat-forming from a sheet of polymeric material.

In alternative embodiments, to obtain more environmentally sustainable solutions, the invention also contemplates the possibility of using other materials, such as polylactic acid or cellulose for the main body 6 and the lid 26.

Any type of infusion may be produced in the capsule 2 according to the invention, such as coffee, tea, cocoa, mate or the like or also soluble products.

On the injection side 30 of the rim 12, the capsule 2 is provided with a sealing member 14. The sealing member 14 comprises an annular groove 16 surrounding the main body 6. As may be seen in the figures, the groove 16 is formed by the side wall 18 of the main body 6 and a remote wall 20 from the main body 6. This groove 16 narrows from the injection side 30 towards the extraction side with an asymmetrical approximately V shape and extends to a floor 38 of the groove 16. Particularly, the slope angle of the side wall 18 of the main body 6 relative to the main axis 28 is greater than the slope angle of said remoter wall 20 relative to the same axis, it should also be pointed out that the symmetrical V or straight wall shape as the side wall 18 it is not absolutely necessary. Both walls may be slightly concavely or convexly shaped and would provide the same effect. In any case, in the invention the walls must narrow towards the floor 38 of the groove 16 and not be vertical. Thus, in the operative position, simultaneous contact of the enclosing member 102 against both walls may be guaranteed, by bearing against tight curves all around it. In the case of a greater deformation, these curves could be small annular surfaces on each of the side walls of the groove 16.

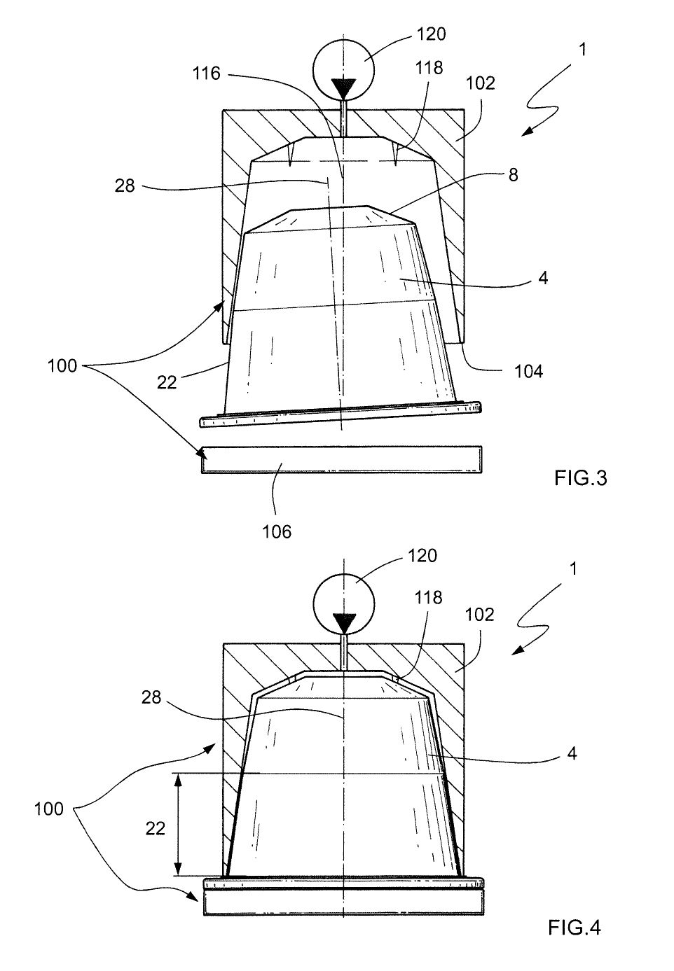

The configuration of the unit 1 for preparing infusions according to the invention is better to be seen in FIGS. 3 and 4. Further to the capsule 2, the unit 1 comprises a device 100 for preparing infusions, shown very schematically in the figures. The device 100 is a machine for preparing infusions from single-dose capsules, by causing a liquid, such as, for example, water, to pass under pressure at between 1 and 20 bar through the inner chamber 4 of the capsule 2 and which is common in the conventional art.

In the figures there is shown only one enclosing member 102 provided on the injection side of the device 100 and an extraction wall 106 on the extraction side. This enclosing member 102 is configured to receive the capsule 2 in the interior thereof. Opposite to this enclosing member 102, the device 100 there is the fixed extraction wall 106, provided with liquid passages 108 and perforation means 110, against which the capsule 2 may be opened by the liquid pressure.

It may also be appreciated in the figures that the enclosing member 102 is provided with a leading sealing edge 104.

The unit 10 has a rest position in which the leading sealing edge 104 is remote from the sealing member 14 and an operative position in which the leading edge 104 of the enclosing member 102 is compressed against the sealing member 14.

As explained hereinabove, to obtain optimum results in the preparation of the beverage, it is important to achieve good fluid tightness the perimetrical contact area between the leading edge 104 and the sealing member 14. Thus, to solve this problem, during the preparation of the beverage, the groove 16 and the leading edge 104 are configured such that, in the operative position, the leading edge 104 is inserted in the groove 16 and is sealedly compressed, simultaneously against the side wall 18 of the main body 6 and the remote wall 20 of the groove 16. This feature is to be seen particularly well in FIG. 2. Thanks to this, there are formed two perimetrical curves of contact between the enclosing member 102 and the sealing member 14, notably improving the fluid tightness. It should also be highlighted that another important advantage in the unit according to the invention is provided by the fact that the side wall 8 itself of the capsule 2 forms part of the groove 16, such that a guiding function is obtained in the leading edge 104 making it very hard for offsetting to occur between the enclosing member 102 and the capsule 2. As already explained hereinabove, such offsetting was one of the unresolved problems of the conventional capsules.

This guidance provided by the walls of the groove 14 itself is notably improved when the capsule 2 itself also has a guide area 22 on the side wall 18 extending from the floor of said annular groove 16 to at least one third of the height of said capsule 2. Thereby, the capsule 2 progressively places itself correctly, as shown in FIGS. 3 and 4.

Also, in this first embodiment of the capsule 2 according to the invention, the inner wall of the enclosing member 102 and the side wall 18 of the capsule 2 have mating shapes in the guide area.

The grove 16 of the capsule 2 according to the invention may be formed in different forms. For example, the rim 12 could be simply a completely flat disc such as for example in FIG. 5, and the groove 16 would only be a peripheral indentation of any optimum profile to fulfil the desired function. Nevertheless, in the embodiment shown in the figures, the remote wall 20 of the sealing member 14 is formed between the side wall of the main body 6 and an annular protrusion 24, preferably deformable on being compressed by the enclosing member 102. The deformation may be elastic, but it could also be plastic.

In one particular embodiment providing the technical effect pursued by the invention, the leading edge 104 of the enclosing member 102 has an inner diameter 112 comprised between 29.8 and 30.4 mm and an outer diameter 114 comprised between 30.6 and 32 mm. In turn, in the capsule 2, the side wall 18 in the region of the groove 16 is inclined between 14 and 17.50 relative to the main axis 28, while the remote wall 20 is inclined between 15 and 450 relative to the same main axis 28. On the other hand, the groove 16 has a maximum height 34 comprised between 0.8 and 3 mm measured from the lowest point of the extraction side, and a depth 36 comprised between 0.5 and 1.5 mm measured from the maximum height 34 to the floor 38 of the groove 16. As may be seen in FIG. 2, the floor 38 of the grove 16 is the lowest point thereof. Thus, for example, one way of measuring the depth 36 if the floor 38 ends in a radius, would be to measure the distance between the maximum height 34 and the point of tangency of the radius marking the floor 38.

The method for preparing infusions according to the invention, from a capsule 2 and a device 100 such as those described in the foregoing paragraphs, is as follows: firstly, the capsule 2 is inserted in the device 100 and more particularly in the capsule holder which is formed by a fixed part and a moving part. In the example shown in FIGS. 3 and 4, the fixed part is the extraction wall 106 while the moving part is the enclosing member 102. Nevertheless, both parts could have exchanged functions, such that the extraction wall 106 would move and the enclosing member 102 would be static. On the other hand, the device 100 may have a vertical or horizontal capsule holder. That is, when the capsule 2 is put into place, the rim 12 may be in a horizontal or vertical position. Especially if the capsule 2 is placed in a horizontal position, then the extraction wall 106 would include a guide for holding the capsule rim.

The unit 1 according to the invention has a rest position in which the capsule 2 is inserted in the device 100. In this starting position, not shown in the figures, the enclosing member 102 and, more particularly, the leading edge 104 is remote or separated from the sealing member 14 of the capsule 2. From this position, the movement of the enclosing member 102 towards the extraction wall 106 starts. FIG. 3 shows an indeterminate moment of this movement. At this moment, the main axis 28 of the capsule 2 is not parallel relative to the axis 116 of the enclosing member 102. Nevertheless, as from when the enclosing member touches the guide area 22, it starts correcting the orientation of the capsule 2 in order progressively to cause the main axis 22 and the axis 116 of the enclosing member 102 to align so that the capsule 2 is centered relative to the enclosing member 102. The offsetting between the capsule 2 and the enclosing member 102 may be caused by a linear movement between the main axis 28 and the axis 116 of the machine, namely, both axes would be parallel, but not coaxial. An angular movement between both axes could occur, or finally, a combination of angular and linear movements.

Precisely, this guiding allows the leading edge 104 of the enclosing member 102, as it approaches the extraction wall 106, to be inserted without difficulty in the groove 16 of the capsule 2 and the unit 1 assumes an operative position in which the leading sealing edge 104 is compressed against the sealing member 14. This provides the fluid tightness, as shown in FIG. 4, and the alignment between the enclosing member 102 and the capsule 2 is optimum. It should also be pointed out that the guiding prevents the enclosing member 102 from pressing outside the groove 16, which would cause liquid losses during the preparation of the beverage. In any case, to achieve the optimum fluid tightness, the most important requirement is that the floor diameter 40 of the groove 16 should be greater than the inner diameter 112 of the enclosing member 102 and, in turn, smaller than the outer diameter 114 of the enclosing member 102 and that it should progressively narrow towards the floor 38, which is to be seen clearly in FIG. 2. Particularly, in this case, the floor diameter is defined either as the distance between the main axis 28 of the capsule 2 and the point of intersection of the side and remote walls 18, 20, or, if this intersection point is rounded, as the distance between the main axis 28 and the centre of the radius between these two curves. The skilled person will know different ways of measuring this geometry, such as, for example, by a profile projector, or with a similar measuring system.

The enclosing member 102 also has punches 118 at the bottom thereof. These are configured so that, when passing to the operative position, they perforate the upper base 8 of the capsule 2, as shown in FIG. 4.

In this situation, the method of infusion can be started. To this end, the pump 120 which injects the fluid under a pressure of between 1 and 20 bar in the inner chamber 4 is activated. Due to this, there is produced an increase in pressure causing the lid to swell and be compressed against the perforation means 110 (see FIG. 2) and therefore open passages in the extraction side of the capsule 2 and the infusion flows to the outside through the passages 108 provided in the extraction wall 106. From here on, the infusion is directed to a not shown manifold and is channelled towards the container receiving the infusion.

Hereinafter there are illustrated other embodiments of the unit 1 according to the invention sharing a large portion of the features described in the foregoing paragraphs. Consequently, hereinafter there will be described only the differentiating members, while for the common members reference is made to the description of the first embodiment.

In FIG. 5, there is to be seen an embodiment in which the inner wall of the enclosing member 102 is not parallel to the guide area 22. In this case, the guiding is effected only by the leading edge 104 of the enclosing member 102.

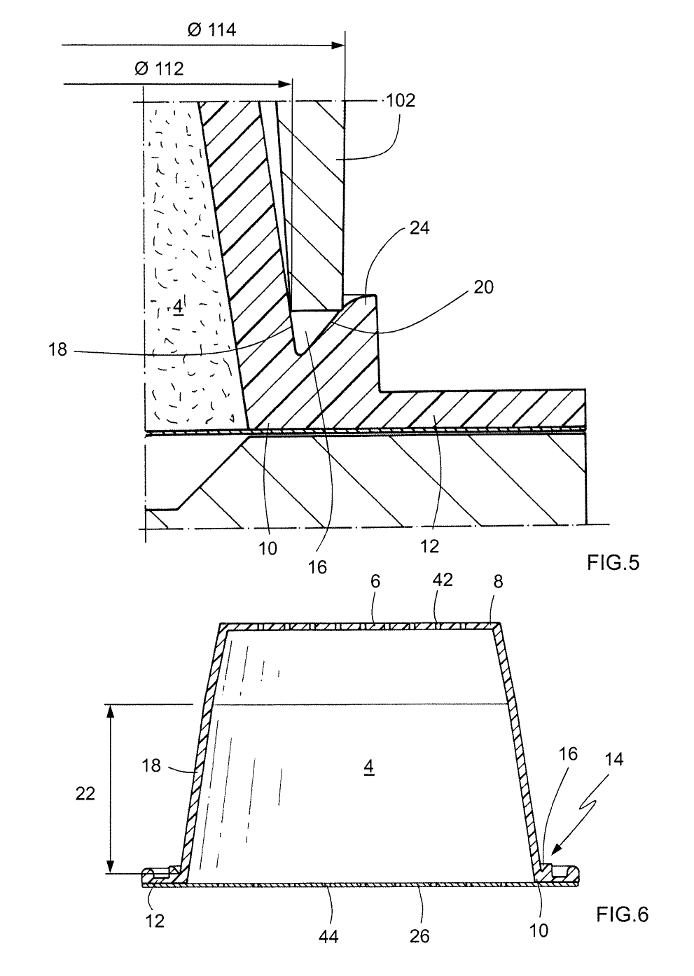

In the embodiment of FIG. 6, the upper base 8 of the main body 6 has a plurality of first passages 42, while the lid 26 has also a plurality of second passages 44. In this case, the capsule 2 itself would not have a barrier property. To this end, to guarantee a good preservation of the infusion product, the capsule 2 must be packaged in a laminate having this property such as, for example, a laminate composed of aluminium and a polymer such as polythene.

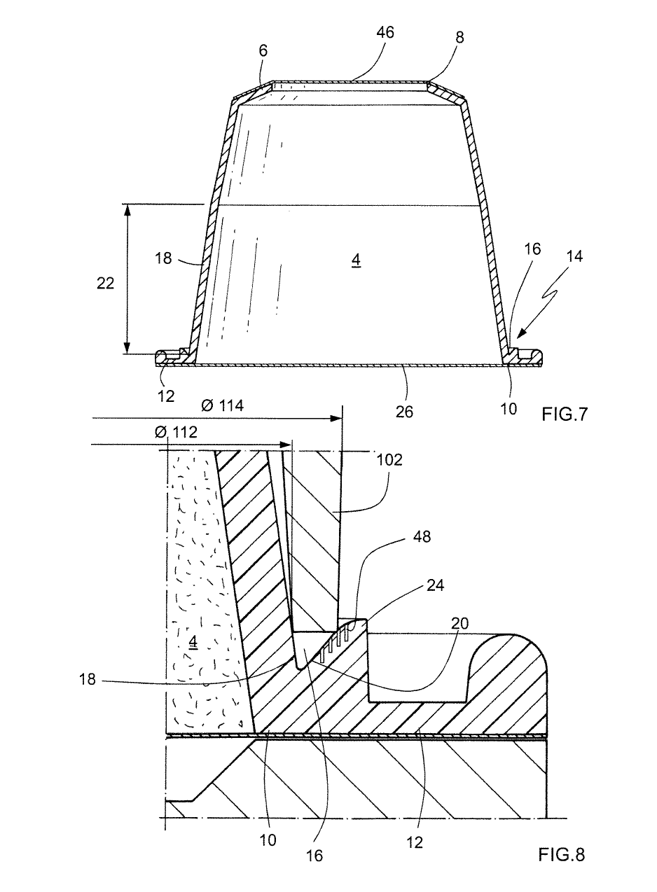

The embodiment of FIG. 7 is differentiated by the fact that the upper base 8 is open. Thus, in this case, the opening is covered with an upper laminated covering 46 made from materials such as aluminium or a polymer or combinations thereof. The upper covering 46 may have characteristics similar to those of the lid 26.

In the embodiment of FIG. 8, the remote wall 20 of the sealing member 14 comprises a plurality of punctual blind holes 48 penetrating in this wall of the sealing member 14. This embodiment is especially advantageous, since the support surface for the leading edge 104 of the enclosing member 102 is reduced and a greater surface pressure is obtained. This facilitates the occurrence of a plastic deformation of this wall and that, therefore, a better fluid tightness is achieved between the enclosing member 102 and this wall of the sealing member 14.

The embodiments described up to here represent non-limiting examples, such that the man of the art will understand that, beyond the examples shown, within the scope of the invention, multiple combinations among the features claimed and the embodiments shown are possible.

1.-10. (canceled)

11. A unit for preparing infusions, comprising:
a capsule including—
a truncated cup-shaped main body defining a main axis and having an upper base and an open lower base,
a lid for closing said lower base and forming an inner chamber with said main body in which there is contained an infusion product,
a perimetrical rim projecting outwardly from said lower base and having an injection side and an extraction side, and
a sealing member, provided on said injection side of said rim; and
a device for preparing infusions including—
a truncated-cone-shaped enclosing member configured to receive said capsule and having a circular leading sealing edge, said device being configured to prepare the infusion by causing a liquid to pass under pressure through said inner chamber, said leading sealing edge having an annular cross section defining an inner diameter and an outer diameter,
wherein said unit has a rest position in which said leading sealing edge is remote from said sealing member and an operative position in which said leading sealing edge is compressed against said sealing member to provide fluid tightness during the preparation of said infusion,
wherein said sealing member includes an annular groove surrounding the main body and which is formed by a side wall of said main body and a remote wall from said main body, said groove narrowing from the injection side towards the extraction side, said groove having a floor and said remote wall sloping between 15 and 45° relative to the main axis,
wherein said groove and said leading edge are configured so that, in the operative position, said leading edge is inserted in said groove and is sealingly compressed simultaneously on said side wall of said main body and said remote wall,
wherein said leading edge has an inner diameter between 29.8 and 30.4 mm and an outer diameter between 30.6 and 32 mm,
wherein said floor of said groove defines a floor diameter that is greater than said inner diameter of the enclosing member and smaller than said outer diameter of the enclosing member,
wherein said side wall in a region of said groove slopes at an angle between 14 and 17.5° relative to said main axis, and
wherein said groove has a maximum height between 0.8 and 3 mm measured from a lowest point of said extraction side and a depth between 0.5 and 1.5 mm measured from said maximum height, to the floor of said groove.

12. The unit according to claim 11, wherein said capsule has a guide area on said side wall extending from the floor of said annular groove to at least one third of the height of said capsule.

13. The unit of claim 12, wherein an inner wall of said enclosing member and the side wall of said capsule have mating shapes in said guide area.

14. The unit according to claim 11, wherein said remote wall of said sealing member is formed by a deformable annular protrusion.

15. The unit according to claim 11, wherein said remote wall comprises a plurality of holes penetrating said sealing member so that said sealing member is deformable under pressure during the preparation of said infusion.

16. The unit according to claim 11, wherein said annular groove narrows from said injection side towards said extraction side asymmetrically.

17. The unit of claim 16, wherein the angle of slope of said side wall of said main body relative to said main axis is smaller than an angle of slope of said remote wall relative to said main axis.

18. A capsule for use in a device for preparing infusions including a truncated-cone-shaped enclosing member configured to receive said capsule and having a circular leading sealing edge with an annular cross section defining an inner diameter and an outer diameter, said device being configured to prepare an infusion by causing a liquid to pass under pressure through said capsule and said leading sealing edge having an inner diameter between 29.8 and 30.4 mm and an outer diameter between 30.6 and 32 mm, said capsule comprising:
a truncated cone cup-shaped main body defining a main axis and having an upper base and an open lower base,
a lid for closing said lower base and forming an inner chamber with said main body in which there is contained an infusion product,
a perimetrical rim extending outwardly from said lower base and having an injection side and an extraction side; and
a sealing member provided on said injection side of said rim,
wherein said sealing member includes an annular groove surrounding the main body and which is formed by a side wall of said main body and a remote wall from said main body, said groove narrowing from the injection side towards the extraction side, and said groove having a floor defining a floor diameter, and said remote wall sloping at an angle between 15 and 450 relative to said main axis,
wherein said floor diameter of said groove is greater than said inner diameter of the enclosing member and smaller than said outer diameter of the enclosing member,
wherein said side wall in a region of said groove slopes at an angle between 14 and 17.50 relative to said main axis, and
wherein said groove has a maximum height between 0.8 and 3 mm measured from a lowest point of said extraction side and a depth between 0.5 and 1.5 mm measured from said maximum height, to the floor of said groove.
